(19) United States
(12) Patent Application Publication
(10) Pub. No.: US 2007/0147667 A1
(43) Pub. Date: Jun. 28, 2007

(54) Biometrics information processing device and method

(75) Inventors: Tomoaki Sumita, Suzuka-shi (JP); Manabu Yumoto, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/643,991

(22) Filed: Dec. 22, 2006

(30) Foreign Application Priority Data
Dec. 26, 2005 (JP) 2005-371320 (P)

(51) Int. Cl. G06K 9/00

(52) U.S. Cl. 382/124

(57) ABSTRACT

A sensing device includes first sensor elements allocated on a two-dimensional plane, and a second sensor element allocated on the same plane as the first sensor element and operating according to a manner different from that of the first sensor element. A signal processing unit generates a fingerprint image based on an output signal of the first sensor element after detecting placement of a finger based on an output signal of the second sensor element, and collates the generated fingerprint image with a previously registered fingerprint image. A capacitance type sensor element is used as the first sensor element, and a pressure sensitive sensor element is used as the second sensor element.

This nonprovisional application is based on Japanese Patent Application No. 2005-371320 filed with the Japan Patent Office on Dec. 26, 2005, the entire contents of which are hereby incorporated by reference.

### BACKGROUND OF THE INVENTION

1. Field of the Invention

The present invention relates to biometrics information processing device and method which obtain and process information such as a fingerprint peculiar to a living body.

2. Description of the Background Art

In recent years, a biometrics authentication technique has been developed and partially brought into active use. This technique uses information peculiar to a living body (which will be referred to as “biometrics information” hereinafter), i.e., information relating to a fingerprint, an iris, a blood-vessel pattern, a face form and the like, and thereby authenticates personal identification. Among techniques for the biometrics authentication, many techniques have been developed for fingerprint authentication that uses fingerprint images for authenticating the personal identification.

FIG. 10 is a flowchart of general fingerprint authentication processing. A biometrics information processing device performing the fingerprint authentication includes a fingerprint sensor, and executes three steps illustrated in FIG. 10. The biometrics information processing device first detects that a finger is placed on the fingerprint sensor in a finger placement detecting step (step S1). Then, in a sensing step (step S2), the device obtains a fingerprint image provided from the fingerprint sensor. Finally, in a fingerprint collating step (step S3), this device collates the fingerprint image obtained in the sensing step with a fingerprint image already registered.

The fingerprint sensors can be divided into two types, i.e., an optical type and a non-optical type. The non-optical fingerprint sensor has a feature that it allows reduction of size and cost as compared with the optical fingerprint sensor. Capacitance type fingerprint have been wisely known among the non-optical fingerprint sensors. An example of the capacitance type fingerprint sensor has been disclosed in Japanese Patent Laying-Open No. 04-231803. When a finger placed on a sensor plane of the capacitance type fingerprint sensor, a concavity and a convexity in a fingerprint are spaced by different distances from the sensor plane, and therefore cause different capacitances, respectively. Based on this feature, the fingerprint sensor provides a signal indicating the fingerprint image.

The conventional biometrics information processing device provided with a capacitance type fingerprint sensor detects the finger placement in the following method. From a comparison between the state where a finger is placed on a sensor plane and the state where the finger is not placed thereon, it can be understood that a charge accumulation speed of a sensor element (capacitor) in the former state is higher than that in the latter state. Therefore, the determination whether the finger is already placed or not can be performed based on a magnitude of a total quantity of charges accumulated in a predetermined number of sensor elements within a predetermined time. For example, it is assumed that an accumulated charge quantity Q1 changes as represented by solid line in FIG. 11A when a finger is placed, and an accumulated charge quantity Q0 changes as represented by broken line when the finger is not placed. In this case, the biometrics information processing device determines that the finger is placed when a difference ΔQ1 (=Q1−Q0) in accumulated charge quantity is equal to or larger than a predetermined threshold.

As a technique relating to the invention, Japanese Patent Laying-Open No. 2005-024480 has disclosed a sensor for surface form recognition in which capacitance type capacitance sensing elements and MEMS (Micro Electro Mechanical Systems) type capacitance sensing elements are arranged alternately to each other. This reference has disclosed a method of sensing two kinds of fingerprint images, using the two kinds of sensing elements.

However, the conventional biometrics information processing device using the capacitance type fingerprint sensor cannot accurately detect the finger placement in some cases. For example, the charge accumulation speed at the time when a dry skin of finger is placed on a sensor plane may be equal to the charge accumulation speed at the time when the finger is not placed. In this case, the biometrics information processing device cannot accurately detect the finger placement. More specifically, an accumulated charge quantity Q2 may change as represented by solid line in FIG. 11B when a person having a dry skin places his/her finger on the sensor plane. In this case, a difference ΔQ2(=Q2−Q0) in accumulated charge quantity may not attain a predetermined threshold. When the finger placement cannot be detected accurately as described above, the biometrics information processing device cannot execute the processing (sensing and fingerprint collation) after the finger placement is detected.

It is preferable that a time required for fingerprint authentication is short. However, the above finger placement detecting method described above requires a long time for one operation of detecting the placement of the finger or may fail to detect the finger placement may be repeated, in which case a long time is required for the fingerprint authentication, and large power consumption is required for detecting the finger placement.

### SUMMARY OF THE INVENTION

An object of the invention is to provide biometrics information processing device and method that can detect a living body at a high speed with low power consumption.

For achieving the above objects, an aspect of the invention provides a biometrics information processing device for obtaining and processing biometrics information, including a sensing device including first sensor elements allocated in a two-dimensional fashion and a second sensor element allocated on the same plane as the first sensor elements and operating according to a manner different from that of the first sensor element; and a signal processing unit detecting a living body based on an output signal of the second sensor element, subsequently obtaining the biometrics information based on an output signal of the first sensor element and executing predetermined processing on the obtained biometrics information.

Preferably, the first sensor element is a capacitance type sensor element. Accordingly, it is possible to obtain the biometrics information that can be obtained using the capacitance type sensor element.

Preferably, the second sensor element is a pressure sensitive sensor element. Accordingly, the living body can be detected when the living body comes into contact with the second sensor element.

Preferably, the first sensor element provides a signal representing a fingerprint image. Accordingly, the fingerprint image can be obtained as the biometrics information, and the predetermined processing can be executed on the obtained fingerprint image.

Preferably, the signal processing unit produces a fingerprint image based on the output signal of the first sensor element, and collates the produced fingerprint image with a previously registered fingerprint image. Accordingly, the fingerprint authentication can be performed by collating the obtained fingerprint image with the registered fingerprint image.

Preferably, the second sensor element is allocated at a center of an allocation region of the first sensor element. Accordingly, it is possible to detect the living body located at the center of the allocation region of the first sensor element.

Preferably, the second sensor element(s) are smaller in number than the first sensor elements. Accordingly, the living body can be detected using a small number of second sensor element(s), whereby the time and power consumption required for the living body detection can be reduced.

Preferably, the one second sensor element is allocated in an allocation region of the first sensor element. Accordingly, the living body can be accurately detected while minimizing an influence that may be exerted on processing subsequent to the living body detection due to the existence of the second sensor element.

Preferably, the plurality of second sensor elements are allocated in an allocation region of the first sensor element. Accordingly, the detection accuracy can be improved by detecting the living body using the plurality of second sensor elements. Further, even when one or some of the second sensor elements failed, the living body can be precisely detected using the other second sensor elements.

Preferably, the second sensor elements are allocated continuously in a one-dimensional fashion in an allocation region of the first sensor element. Accordingly, it is possible to detect accurately the living body that is located in a position shifted in a direction of a series of the allocated second sensor element.

Preferably, the second sensor elements are allocated in a one-dimensional fashion in an allocation region of the first sensor element and are spaced from each other. Accordingly, it is possible to suppress an influence that may be exerted on the processing subsequent to the living body detection due to the existence of the second sensor element, and the living body located in a position shifted in a direction of a series of the allocated second sensor elements can be accurately sensed.

Preferably, the second sensor elements are allocated continuously in a two-dimensional fashion in an allocation region of the first sensor element. Accordingly, by continuously allocating the second sensor elements, the durability of the second sensor elements can be improved as compared with the case where they are spaced form each other.

Preferably, the second sensor elements are allocated in a two-dimensional fashion in an allocation region of the first sensor element, and are spaced from each other. Accordingly, it is possible to detect accurately the living body that is shifted within the range of allocation of the second sensor elements.

Preferably, the second sensor elements are allocated in an allocation region of the first sensor element, and are divided into groups spaced from each other in a two-dimensional fashion, and the second sensor elements in each of the groups are allocated continuously. Accordingly, it is possible to detect accurately the living body that is located in a position shifted within the range of allocation of the second sensor elements, and the durability of the second sensor elements can be improved as compared with the case where they are spaced form each other in each group.

Preferably, when the living body detection is indicated by a predetermined number or a predetermined rate of the output signals among the output signals of the second sensor elements, the signal processing unit determines that the living body is detected. Accordingly, the living body can be detected further accurately by performing the determination based on the output signals of the plurality of second sensor elements.

For achieving the foregoing objects, another aspect of the invention provides a biometrics information processing method for obtaining and processing biometrics information, using a sensing device including first sensor elements allocated in a two-dimensional fashion, and a second sensor element allocated on the same plane as the first sensor element and operating in a manner different from that of the first sensor element. More specifically, this method includes the steps of: detecting the living body based on the output signal of the second sensor element; obtaining biometrics information based on the output signal of the first sensor element; and executing predetermined processing on the obtained biometrics information.

For achieving the foregoing objects, a still another aspect of the invention provides a program for causing a computer to execute biometrics information processing of obtaining and processing biometrics information. This program causes the computer to execute the steps of: detecting the living body based on the output signal of the second sensor element; obtaining biometrics information based on the output signal of the first sensor element; and executing predetermined processing on the obtained biometrics information.

For achieving the foregoing objects, a yet another aspect of the invention provides a computer-readable record medium bearing the above program.

Accordingly, by using the computer and the program for executing the biometrics information processing, it is possible to provide the biometrics information processing device and biometrics information processing method that can accurately and rapidly detect the living body with low power consumption.

According to the invention, the sensing device is provided with two kinds of, i.e., the first and second sensor elements. The living body detection is performed using the output signal of the second sensor element, and the processing subsequent to the living body detection is performed using the output signal of the first sensor element. Therefore, by using the sensor element suitable for the living body detection as the second sensor element, the living body can be detected more accurately than the prior art. Since the living body can be detected accurately, the time and power consumption required for the living body detection can be reduced. As described above, it is possible to provide the biometrics information processing device or the biometrics information processing method that can accurately sense the living body at a high speed with low power consumption.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a biometrics information processing device according to an embodiment of the invention.

FIGS. 2 and 3 illustrate capacitance type sensor elements according to the embodiment of the invention.

FIG. 4 illustrates a pressure sensitive sensor element according to the embodiment of the invention.

FIG. 5 illustrates an optical sensor element according to the embodiment of the invention.

FIG. 6 shows an example of an allocation of the sensor elements in the biometrics information processing device shown in FIG. 1.

FIGS. 7A-7F show other examples of the sensor elements in the biometrics information processing device shown in FIG. 1.

FIG. 8 is a flowchart illustrating fingerprint authentication processing by a signal processing unit of the biometrics information processing device shown in FIG. 1.

FIG. 9 is a block diagram illustrating a specific example of the biometrics information processing device shown in FIG. 1.

FIG. 10 is a flowchart of general fingerprint authentication processing.

FIG. 11A and 11B illustrate changes in accumulated charge quantity of a capacitance type fingerprint sensor.

### DESCRIPTION OF THE PREFERRED EMBODIMENTS

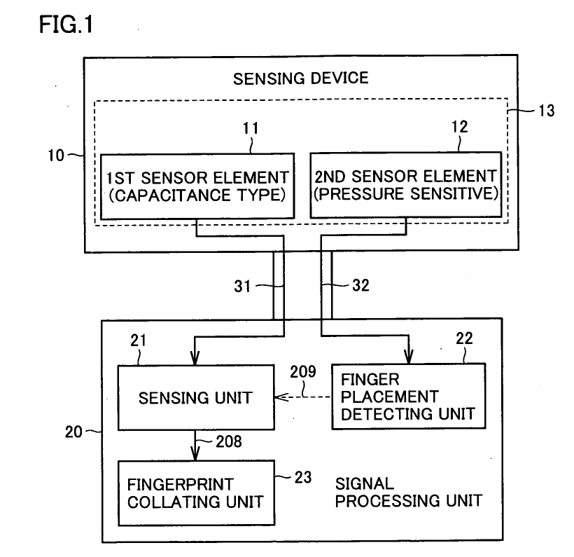

Referring to FIG. 1, a biometrics information processing device according to an embodiment of the invention includes a sensing device 10 and a signal processing unit 20. This device obtains, as biometrics information, an image of a fingerprint representing a feature peculiar to a living body, and performs fingerprint authentication.

Sensing device 10 includes a device plane 13 in which first and second sensor elements 11 and 12 are allocated. First sensor element 11 provides a first sensor output signal 31. Second sensor element 12 operates in a manner different from that of first sensor element 11, and provides a second sensor output signal 32. In this embodiment, first sensor element 11 is a capacitance type sensor element, and second sensor element 12 is a pressure sensitive sensor element. Instead of the capacitance type sensor element, first sensor element 11 may be formed of an optical sensor element, a pressure sensitive sensor element or the like.

Signal processing unit 20 includes a sensing unit 21, a finger placement detecting unit 22 and a fingerprint collating unit 23. Sensing unit 21 has an A/D (analog/digital) converter (not shown), which receives a first sensor output signal 31 provided from each first sensor element 11 of sensing device 10 and corresponding to an image signal, converts it into digital data, i.e., binary data based on a brightness level, thereby generate image data 208 based on the binary data and provides it to fingerprint collating unit 23. Fingerprint collating unit 23 collates input image data 208 with image data that is previously registered, and provides a result of the collation. The collation result indicates either the matching or mismatching of these images.

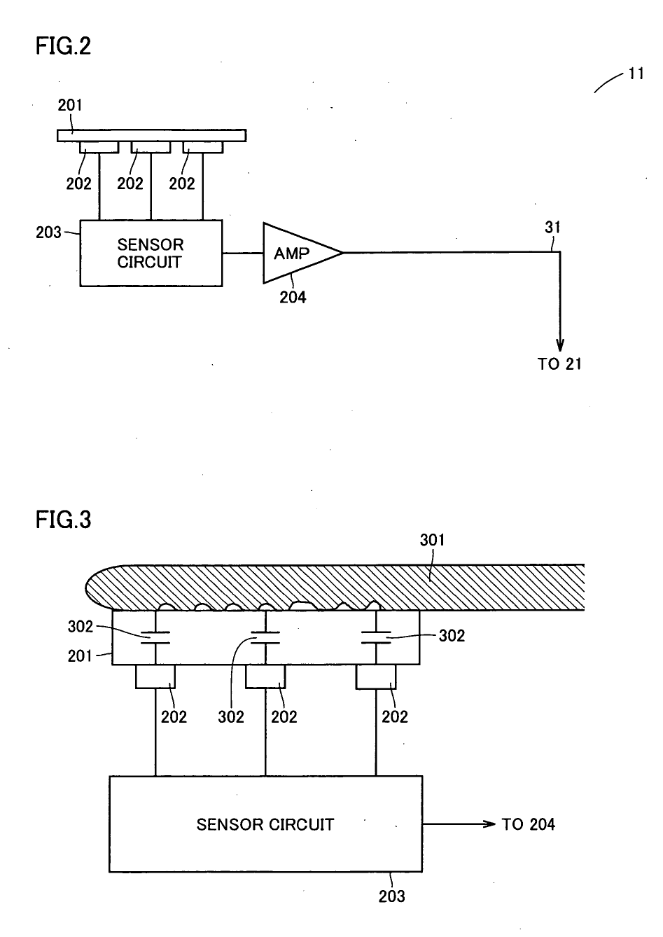

FIGS. 2 to 5 show schematic structures of a capacitance type sensor element, a pressure sensitive sensor element and an optical sensor element. Each type of sensor element has a plane on which a user's finger is to be placed for inputting the fingerprint image. This plane is referred to as an “image-taking plane”. When the finger is placed on the image-taking plane, the sensor elements read the image corresponding to the fingerprint of the placed finger, and provide a signal according to the read image.

Referring to FIG. 2, first sensor element 11 (capacitance type sensor element) includes an image-taking plane 201, a plurality of sensor electrodes 202, a sensor circuit 203 and an amplifier 204. A finger of which fingerprint is to be read is placed on a main plane (i.e., an externally exposed plane) of image-taking plane 201. A structure of sensor circuit 203 will be described later. Amplifier 204 receives and amplifies a voltage signal representing an image signal provided from sensor circuit 203 to provide an amplified voltage signal as first sensor output signal 31.

FIG. 3 schematically shows structures of and around the plurality of sensor electrodes 202 in a state where a finger 301 having a fingerprint to be read is placed on the main plane of image-taking plane 201. When finger 301 is placed on the main plane of image-taking plane 201, a capacitor 302 is formed between each sensor electrode 202 and finger 301. Since the fingerprint of finger 301 has convexities and concavities, finger 301 placed on the main plane of image-taking plane 201 is spaced from sensor electrodes 202 by different distances, respectively, so that capacitors 302 formed between them have different capacitances, respectively. Sensor circuit 203 detects the differences in capacitance between capacitors 302 based on the output voltage levels of electrodes 202, converts the detected differences to a voltage signal and provides it to amplifier 204. Thus, first sensor output signal 31 (voltage signal) provided from sensor circuit 203 corresponds to the image representing the state of convexities and concavities of the fingerprint placed on the main plane of image-taking plane 201.

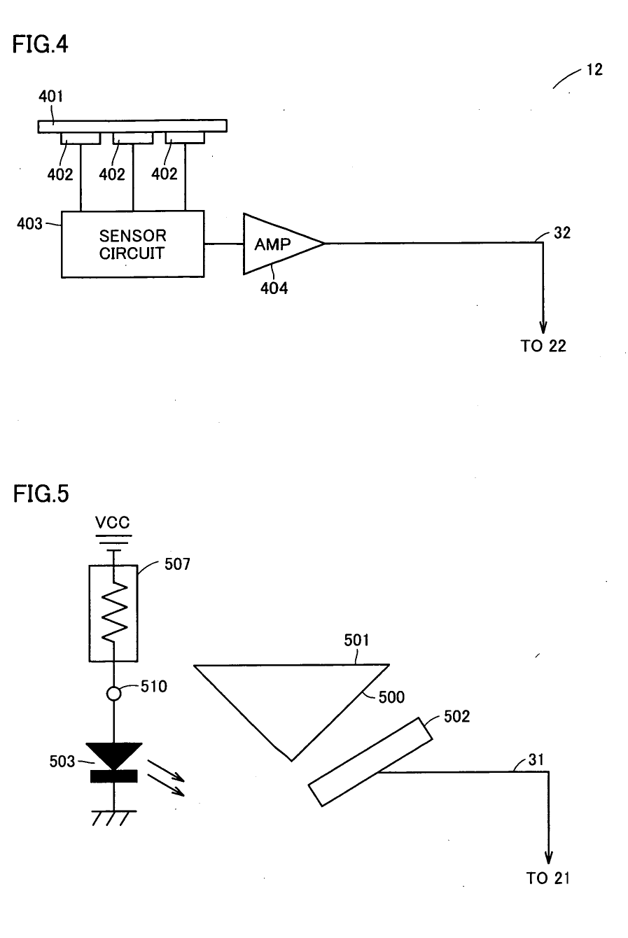

Referring to FIG. 4, second sensor element 12 (pressure sensitive sensor element) includes an image-taking plane 401, a plurality of piezoelectric sensor electrodes 402, a sensor circuit 403 and an amplifier 404.

The finger of which fingerprint is to be read is placed on the externally exposed main plane of image-taking plane 401. A plurality of piezoelectric sensor electrodes 402 are allocated on a plane opposite to the main plane. Amplifier 404 receives the voltage signal representing the image signal from sensor circuit 403, and amplifies it to provide the amplified signal as second sensor output signal 32.

Piezoelectric sensor electrode 402 detects the pressure applied from an object placed on image-taking plane 401, and sensor circuit 403 converts the pressure detected by piezoelectric sensor electrode 402 to a voltage signal, and outputs it. The voltage signal, i.e., image signal provided from sensor circuit 403 is amplified by amplifier 404, and then is output as second sensor output signal 32.

Referring to FIG. 5, an optical sensor element includes a prism 500 having an image-taking plane 501 on which a finger having a fingerprint to be read is placed thereon, a CCD (Charge Coupled Device) camera 502 for taking an image of the fingerprint, an LED (Light Emitting Diode) 503 and a resistor 507. Since LED 503 emits light beams into prism 500, the finger placed on image-taking plane 501 is irradiated with the light beams emerging from prism 500.

CCD camera 502 takes the image of the fingerprint of the finger placed on image-taking plane 501, using the light beams emitted from LED 503 as illuminating light for the image-taking, and provides first sensor output signal 31 corresponding to the fingerprint image. A CPU 41 to be described layer controls the image-taking operation of CCD camera 502.

A resistor 506 is connected to a constant voltage supply VCC, and an input terminal 510 of LED 503 is supplied with a voltage from constant voltage supply VCC via resistor 506. LED 503 emits the light of an emission quantity according to a level of current supplied thereto.

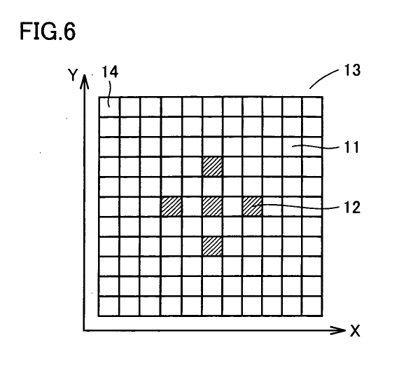

Sensing device 10 has device plane 13 that is externally exposed for allowing contact (pressing by a finger in the embodiment) with a living body. A major portion of device plane 13 forms a region where first sensor elements 11 are to be allocated, and second sensor elements 12 are allocated in the remaining region. Referring to FIG. 6, device plane 13 indicates a two-dimensional flat plane of a rectangular form defined by X- and Y-axes perpendicular to each other. Device plane 13 is equally divided in a direction of the X-axis into eleven portions, and is equally divided in a direction of the Y-axis into eleven portions. Therefore, device plane 13 has 121 square cellS14 of the same size. Although cells 14 are 121 in number in this embodiment, the number of cells 14 is not restricted to this. Also, the form of device plane 13 is not restricted to the rectangle.

First or second sensor element 11 or 12 is allocated to each cell 14 of device plane 13. In cell 14, the sensor element is arranged with the main plane of its image-taking plane is directed externally.

FIG. 6 shows an example of allocation of the sensor elements in device plane 13 of sensing device 10. In the figure, cell 14 of a blank form represents first sensor element 11, and hatched cell 14 represents second sensor element 12. First sensor elements 11 are allocated in a two-dimensional fashion, and second sensor elements 12 are allocated on the same plane as first sensor elements 11. Second sensor elements 12 are smaller in number than first sensor elements 11, and typically are arranged in a central portion of the region where first sensor elements 11 are allocated. In the example shown in FIG. 6, one second sensor element 12 is allocated in the center of the allocation region of first sensor elements 11, and four second sensor elements 12 are allocated on the upper, lower, left and right sides of the center, respectively. Thus, second sensor elements 12 of five in total are allocated.

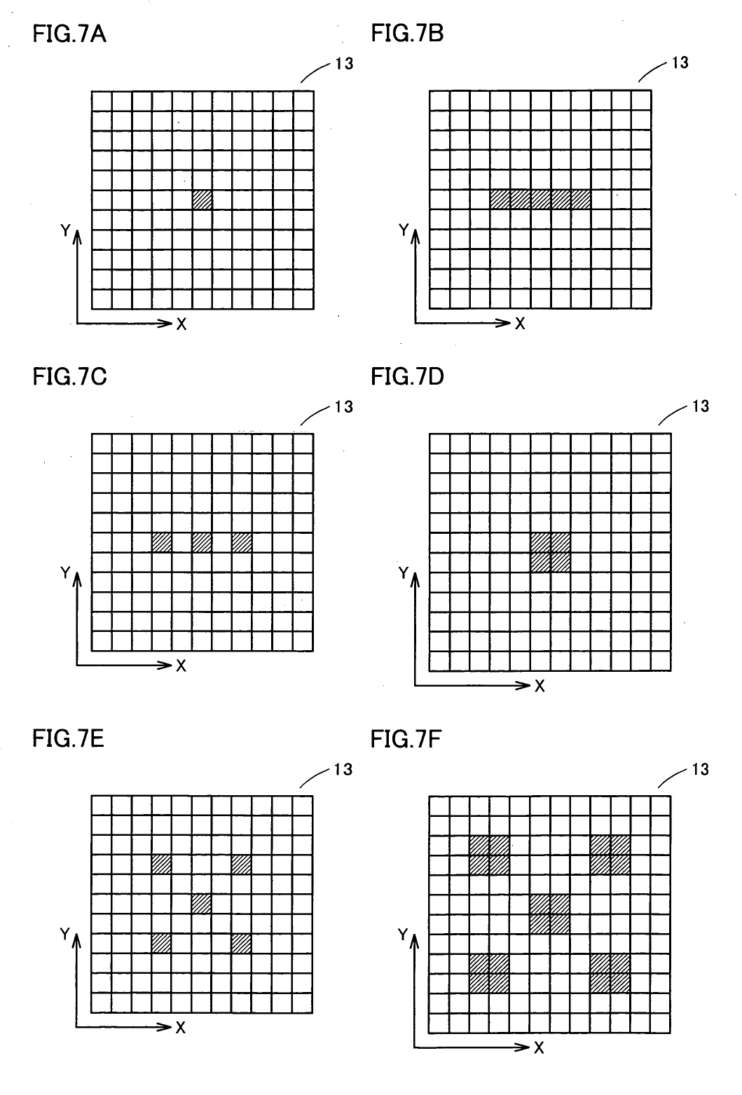

FIGS. 7A-7F show some other examples of the allocation of the sensor elements on device plane 13 of sensing device 10. For the sake of illustration, each of FIGS. 7B and 7D shows the example in which cells of 144 in total number are present in device plane 13. In the example shown in FIG. 7A, only one second sensor element 12 is allocated in the allocation region of first sensor elements 11. In the example shown in FIG. 7B, second sensor elements 12 are allocated continuously in the one-dimensional fashion in the allocation region of first sensor elements 11. In the example shown in FIG. 7C, second sensor elements 12 spaced from each other are allocated in the one-dimensional fashion in the allocation region of first sensor elements 11. According to the allocation shown in FIG. 7D, second sensor elements 12 are allocated continuously in the two-dimensional fashion in the allocation region of first sensor elements 11. In the example shown in FIG. 7E, second sensor elements 12 spaced from each other are allocated in the two-dimensional fashion in the allocation region of first sensor elements 11. In the example shown in FIG. 7F, second sensor elements 12 are divided into groups that are spaced from each other and are allocated in the two-dimensional fashion in the allocation region of first sensor elements 11, and second sensor elements 12 in each group are allocated continuously.

In FIGS. 7B and 7C, second sensor elements 12 are allocated in one row or series extending in the direction of the X-axis. However, second sensor elements 12 may be allocated in one row extending in the direction of the Y-axis or in another direction.

As described above, only one second sensor element 12 may be allocated in device plane 13 where first sensor elements 11 are allocated (see FIG. 7A), or the plurality of second sensor elements 12 may be allocated (see FIGS. 6, and 7B-7F). Naturally, second sensor elements 12 may be allocated in fashions or manners other than those shown in FIGS. 6 and 7A-7F.

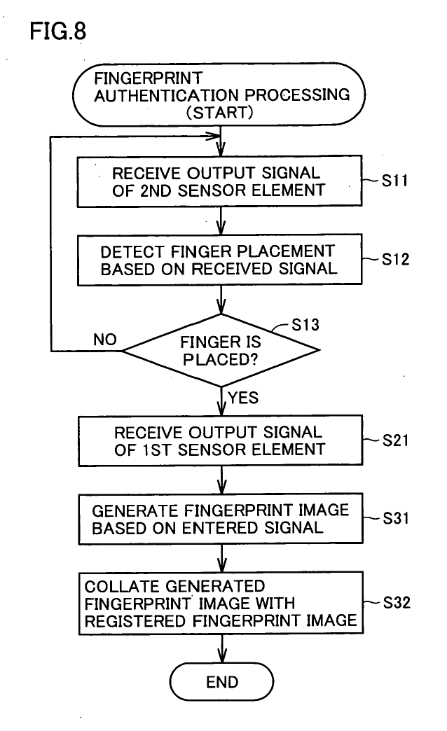

FIG. 8 is a flowchart illustrating a fingerprint authentication processing by signal processing unit 20. As shown in FIG. 8, signal processing unit 20 senses the living body based on second sensor output signal 32 provided from second sensor element 12, and thereafter obtains the fingerprint image based on first sensor output signals 31 provided from first sensor elements 11. Then, signal processing unit 20 executes the fingerprint collation processing on the fingerprint image thus obtained. In FIG. 8, steps S11-S13 correspond to step S1 in FIG. 10, step S21 corresponds to step S2 and steps S31 and S32 correspond to step S3.

In the fingerprint authentication processing illustrated in FIG. 8, signal processing unit 20 first receives second sensor output signal 32 from second sensor element 12 (step S11). Then, signal processing unit 20 operates based on second sensor output signal 32 thus received, and senses the placement of the finger by finger placement detecting unit 22 (step S12). Finger placement detecting unit 22 compares a level of second sensor output signal 32 (corresponding to a voltage signal) applied thereto with a predetermined level. When a result of this comparison indicates that the level of second sensor output signal 32 is equal to or higher than the predetermined level, finger placement detecting unit 22 provides a finger placement completion signal 209. The predetermined level indicates that the detection of the living body succeeded. Signal processing unit 20 performs next processing in step S21 when finger placement detecting unit 22 provides finger placement completion signal 209, i.e., when it determines that the finger is placed (step S13). Otherwise, signal processing unit 20 performs processing in step S11. Signal processing unit 20 repeats processing in steps S11-S13 until the finger placement is detected.

When a result in step S13 indicates Yes, signal processing unit 20 receives first sensor output signals 31 from first sensor elements 11 (step S21). Then, signal processing unit 20 generates fingerprint image data by sensing unit 21 based on first sensor output signals 31 provided thereto (step S31). Signal processing unit 20 has previously registered the fingerprint image data to be collated with the obtained fingerprint image data. Signal processing unit 20 operates to collate the fingerprint image data generated in step S31 with the registered fingerprint image data by fingerprint collating unit 23 (step S32). In step S32, processing such as image correction and pattern matching (search for a maximum matching score position and calculation of a similarity score) is performed for collating the fingerprints.

In the structure that has sensing device 10 including the plurality of second sensor elements 12, finger placement detecting unit 22 may be configured to output finger placement completion signal 209 when a predetermined number or a predetermined rate of second sensor elements 12 (e.g., three or more among, or ⅓ or more of all second sensor elements 12) provide second sensor output signals 32 at the predetermined level or higher. In particular, finger placement completion signal 209 may be output when one or more second sensor element(s) 12 provide second sensor output signal(s) 32 at the predetermined level or higher.

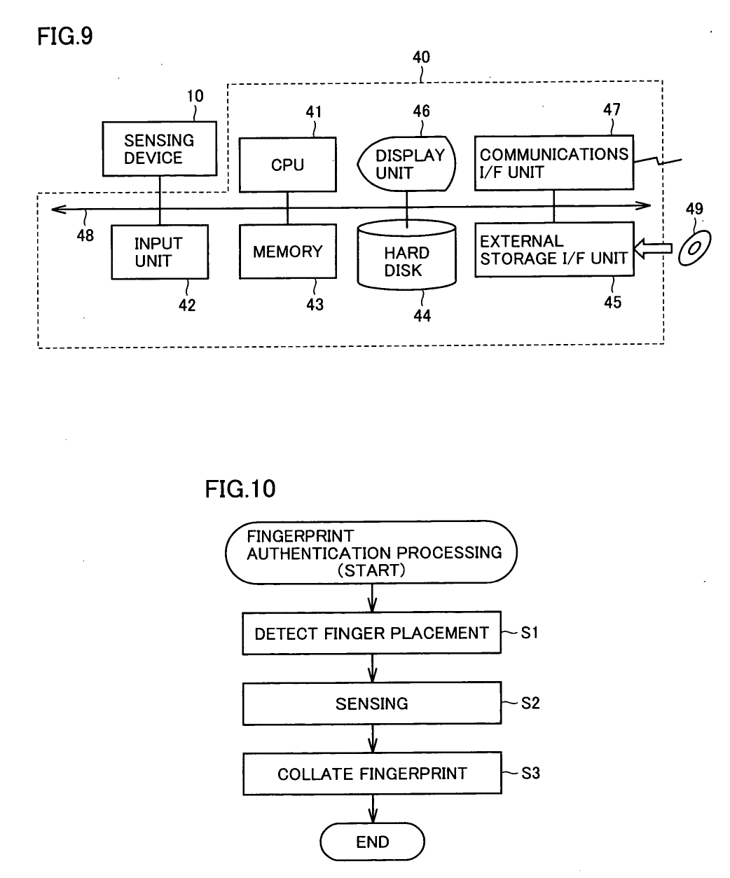

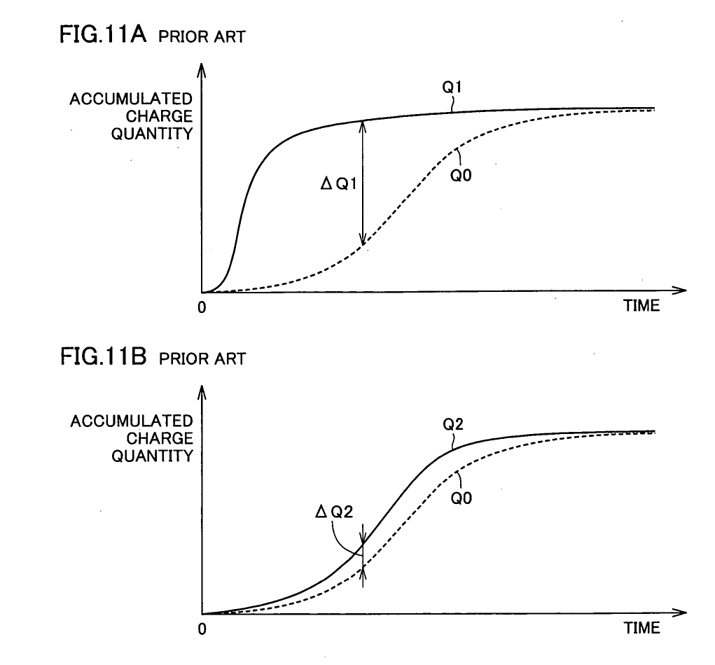

FIG. 9 is a block diagram showing a specific example of the biometrics information processing device according to the embodiment. The biometrics information processing device shown in FIG. 9 includes sensing device 10 and a computer 40. Computer 40 includes a CPU (Central Processing Unit) 41, an input unit 42, a memory 43, a hard disk 44, an external storage I/F (interface) unit 45, a display unit 46 and a communications I/F unit 47. These components are connected to a system bus 48.

In FIG. 9, input unit 42 is formed of an input device(s) such as a keyboard and a mouse. Memory 43 stores various data items and programs, and also functions as a working memory. Hard disk 44 stores the programs and data. External storage I/F unit 45 is an interface circuit for external storage medium 49 such as a CD-ROM (Compact Disk-Read Only Memory) or a flexible disk. Display unit 46 is a display device such as a liquid crystal display device. Communications I/F unit 47 is an interface circuit for performing communications with other computers and the like. Memory 43 has stored data at a predetermined level to be compared with the level of second sensor output signal 32 for detecting the finger placement. Memory 43 or hard disk 44 has previously stored (registered) the fingerprint image data for collation.

External storage medium 49 is a computer-readable record medium, and has stored the programs (which will be referred to as a fingerprint authentication program hereinafter) for executing the fingerprint authentication processing illustrated in FIG. 8. This fingerprint authentication program is read by external storage medium I/F unit 45, and is stored in hard disk 44. Alternatively, the fingerprint authentication program to be stored in hard disk 44 may be received from another computer or the like via communications I/F unit 47.

The fingerprint authentication program is read from hard disk 44 and is transferred to memory 43. Thereafter, the fingerprint authentication program is stored in memory 43. CPU 41 reads and executes the fingerprint authentication program on memory 43. While CPU 41 is executing the fingerprint authentication program, computer 40 functions as signal processing unit 20 (FIG. 1), and thereby the biometrics information processing device shown in FIG. 1 is achieved.

Effects of the biometrics information processing device according to the embodiment will now be described. As described above, the biometrics information processing device according to the embodiment includes sensing device 10 that includes first sensor elements 11 and second sensor element(s) 12 operating in a manner different from first sensor element 11. The living body is detected based on the output signal of second sensor element 12, and the processing subsequent to the detection of the living body is performed based on the output signal of first sensor element 11. Therefore, by using the sensor elements suitable for the living body detection as second sensor element 12, the biometrics information processing device can detect the living body more accurately than the conventional device. Since the living body can be detected accurately, the time and the power consumption required for the living body detection can be reduced. Thus, it is possible to provide the biometrics information processing device that can accurately and rapidly detect the living body with low power consumption.

In particular, by using the capacitance type sensor element as first sensor element 11, it is possible to obtain the biometrics information that can be obtained using the capacitance type sensor element. By using the pressure sensitive sensor element as second sensor element 12, it is possible to detect the living body when the living body comes into contact with second sensor element 12.

Since first sensor element 11 provides the signal representing the fingerprint image, the fingerprint image can be obtained as the biometrics information, and predetermined processing can be effected on the obtained fingerprint image. In particular, signal processing unit 20 produces the fingerprint image based on the output signal of first sensor element 11, and collates the fingerprint image thus produced with the registered fingerprint image so that the fingerprint authentication can be performed.

Since second sensor element 12 is allocated at the center of the allocation region of first sensor elements 11, it is possible to detect the living body located at the center of the allocation region of first sensor elements 11. Since second sensor element(s) 12 are smaller in number than first sensor elements 11, the living body can be detected using the small number of second sensor elements 12 so that the time and the power consumption required for detecting the living body can be reduced.

By allocating one second sensor element 12 in the allocation region of first sensor elements 11 (FIG. 7A), the living body can be accurately detected while minimizing the influence that may be exerted by the existence of second sensor elements 12 on the processing subsequent to the living body detection.

By allocating the plurality of second sensor elements 12 in the allocation region of first sensor elements 11 (FIGS. 6 and 7B-7F), the plurality of second sensor elements 12 can be used to detect the living body so that the accuracy of the living body detection can be improved. Further, even when one or some of second sensor elements 12 fail, the living body can be detected accurately, using remaining second sensor elements 12.

By allocating second sensor elements 12 continuously in a one-dimensional fashion in the allocation region of first sensor elements 11 (FIG. 7B), it is possible to detect accurately the living body located on the series or row of second sensor elements 12.

By allocating second sensor elements 12 in the allocation region of first sensor element 11 and spacing them from each other in the one-dimensional fashion (FIG. 7C), it is possible to suppress the influence that may be exerted on the processing subsequent to the living body detection by the existence of second sensor elements 12, and it is also possible to detect accurately the living body located on the series or row of second sensor elements 12.

By allocating second sensor elements 12 continuously in the two-dimensional fashion in the allocation region of first sensor element 11 (FIG. 7D), durability of second sensor elements 12 can be improved as compared with the case where second sensor elements 12 are spaced from each other.

By allocating second sensor elements 12 in the allocation region of first sensor element 11 and spacing them from each other in the two-dimensional fashion (FIG. 7E), it is possible to detect accurately the living body located in the area where second sensor elements 12 are allocated.

By allocating the groups of second sensor elements 12 in the allocation region of first sensor element 11 such that the groups are spaced from each other in the two-dimensional fashion and second sensor elements 12 in each group are allocated continuously (FIG. 7F), it is possible to detect accurately the living body located in the area where second sensor elements 12 are allocated, and durability of second sensor elements 12 can be improved as compared with the case where second sensor elements 12 in each group are spaced from each other.

The living body can be detected further accurately by employing signal processing unit 20 which can determine that a predetermined number or a predetermined rate of the output signals among the output signals of second sensor element 12 exhibit a predetermined level of living body detection, and thereby can determine that the living body is detected.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A biometrics information processing device, comprising:
I) a sensing unit including:
I-i) a plane externally exposed for contact with a living body;
I-ii) first sensor elements allocated in a two-dimensional fashion on said plane, and detecting a feature peculiar to said living body to provide a signal indicating said detected feature, and
I-iii) a second sensor element allocated on said plane, and operating according to a manner different from that of said first sensor element to detect said living body and provide a signal indicating a result of the detection; and
II) a signal processing unit generating biometrics information representing said feature based on the output signal of said first sensor element when it is determined based on the output signal of said second sensor element that said living body is detected, and executing predetermined processing, using said generated biometrics information.

2. The biometrics information processing device according to claim 1, wherein
said first sensor element is a capacitance type sensor element.

3. The biometrics information processing device according to claim 1, wherein
said second sensor element is a pressure sensitive sensor element.

4. The biometrics information processing device according to claim 1, wherein
said feature peculiar to the living body represents a fingerprint.

5. The biometrics information processing device according to claim 4, wherein
said signal processing unit generates a fingerprint image based on the output signal of said first sensor element, and collates the generated fingerprint image with a previously registered fingerprint image.

6. The biometrics information processing device according to claim 1, wherein
said first sensor element is allocated in a region included in said plane, and
said second sensor element is allocated in said region.

7. The biometrics information processing device according to claim 6, wherein
said second sensor element is allocated at a center of said region.

8. The biometrics information processing device according to claim 6, wherein
a plurality of said second sensor elements are allocated in said region.

9. The biometrics information processing device according to claim 8, wherein
said second sensor elements are smaller in number than said first sensor elements.

10. The biometrics information processing device according to claim 9, wherein
said second sensor elements are allocated continuously in a one-dimensional fashion in said region.

11. The biometrics information processing device according to claim 9, wherein
said second sensor elements are allocated in a one-dimensional fashion in said region with a space between the neighboring second elements.

12. The biometrics information processing device according to claim 9, wherein
said second sensor elements are allocated continuously in a two-dimensional fashion in said region.

13. The biometrics information processing device according to claim 9, wherein
said second sensor elements are allocated in a two-dimensional fashion in said region with a space between the neighboring second elements.

14. The biometrics information processing device according to claim 9, wherein
groups formed of said second sensor elements are arranged on said plane,
said second sensor elements in said group are allocated continuously in a two dimensional fashion, and
said plurality of groups are allocated in a two-dimensional fashion in said region with a space between the neighboring groups.

15. The biometrics information processing device according to claim 9, wherein
said signal processing unit determines that said living body is detected when a predetermined number or a predetermined rate of said output signals of said second sensor elements among said second sensor elements indicate the success in the living body detection.

16. A biometrics information processing method I) using a sensing unit including:
a plane externally exposed for contact with a living body;
first sensor elements allocated in a two-dimensional fashion on said plane, and detecting a feature peculiar to a living body to provide a signal indicating said detected feature, and
a second sensor element allocated on said plane, and operating according to a manner different from that of said first sensor element to detect said living body and provide a signal indicating a result of the detection; and II) comprising the steps of:
determining based on the output signal of said second sensor element whether said living body is detected or not; and
operating to generate biometrics information representing said feature based on the output signal of said first sensor element and to execute predetermined processing using said generated biometrics information, when it is determined in said determining step that said living body is detected.

17. A program product for a computer to perform a biometrics information processing method, wherein
I) said computer is connected to a sensing unit including:
I-i) a plane externally exposed for contact with a living body;
I-ii) first sensor elements allocated in a two-dimensional fashion on said plane, and detecting a feature peculiar to said living body to provide a signal indicating said detected feature, and
I-iii) a second sensor element allocated on said plane, and operating according to a manner different from that of said first sensor element to detect said living body and provide a signal indicating a result of the detection; and
II) said biometrics information processing method includes the steps of:
determining based on the output signal of said second sensor element whether said living body is detected or not; and
operating to generate biometrics information representing said feature based on the output signal of said first sensor element and to execute predetermined processing using said generated biometrics information, when it is determined in said determining step that said living body is detected.

18. A machine-readable storage device storing instructions executable by a computer to perform a biometrics information processing method, wherein
I) said computer is connected to a sensing unit including:
I-i) a plane externally exposed for contact with a living body;
I-ii) first sensor elements allocated in a two-dimensional fashion on said plane, and detecting a feature peculiar to said living body to provide a signal indicating said detected feature, and
I-iii) a second sensor element allocated on said plane, and operating according to a manner different from that of said first sensor element to detect said living body and provide a signal indicating a result of the detection; and
II) said biometrics information processing method includes the steps of:
determining based on the output signal of said second sensor element whether said living body is detected or not; and
operating to produce biometrics information representing said feature based on the output signal of said first sensor element and to execute predetermined processing using said generated biometrics information, when it is determined in said determining step that said living body is detected.
